(19) United States
(12) Patent Application Publication
(10) Pub. No.: US 2019/0235116 A1
(43) Pub. Date: Aug. 1, 2019

(54) METHOD FOR THE ATTENUATION OF MULTIPLE REFLECTIONS IN SHALLOW WATER SETTINGS

(71) Applicant: DownUnder GeoSolutions Pty Ltd., West Perth (AU)

(72) Inventors: Amarjeet Kumar, West Perth (AU); Gary A. Hampson, Peppermint Grove (AU); Troy Thompson, Doubleview (AU)

(21) Appl. No.: 16/382,618

(22) Filed: Apr. 12, 2019

Related U.S. Application Data
(63) Continuation of application No. PCT/US2017/056274, filed on Oct. 12, 2017.
(60) Provisional application No. 62/407,578, filed on Oct. 13, 2016.

(51) Int. Cl. G01V 1/36

(52) U.S. Cl. CPC G01V 1/368; G01V 2210/324; G01V 2210/1423

(57) ABSTRACT

A method for attenuating multiple reflections from marine seismic signals includes estimating a multichannel prediction filter by minimizing energy between detected seismic signals and seismic signals representing water layer multiple reflections in combination with forcing a sparsity constraint on the estimated multichannel filter. Near offset seismic signals not present in the detected seismic signals are reconstructed by convolving the detected seismic signals with an inverse of the multichannel prediction filter. The multichannel prediction filter is convolved with the reconstructed near offset seismic signals to obtain a final multiple reflection model. The final multiple reflection model is subtracted from the detected seismic signals to obtain multiple reflection attenuated seismic signals.

### CROSS REFERENCE TO RELATED APPLICATIONS

Continuation of International Application No. PCT/US2017/056274 filed on Oct. 12, 2017. Priority is claimed from U.S. Provisional Application No. 62/407,578 filed on Oct. 13, 2016. Both of the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of marine seismic surveying. More specifically, the disclosure relates to attenuation of multiple reflections in shallow water settings.

In marine geophysics it is difficult to acquire signals at very short offsets (surface distance between a seismic energy source and one or more seismic sensors deployed in the water). This is due to acquisition constraints, wherein sources and receivers cannot be brought too close together. This is a problem in very shallow water because primary reflections (reflections from sub-bottom acoustic impedance boundaries), that might normally be used to predict multiples, may be missing from the detected seismic signals. This is why known techniques for multiple reflection attenuation or elimination do not perform well in shallow water.

### BRIEF DESCRIPTION OF THE DRAWINGS

FIG. 1 shows an example implementation of acquiring marine seismic data.

FIG. 2 shows a flow chart of an example implementation of a method according to the present disclosure.

FIGS. 3A through 3E show an example water layer and sub bottom formation to illustrate an example embodiment according to the present disclosure.

FIGS. 4A through 4E show another example water layer and sub bottom formations to illustrate another example embodiment.

FIG. 5 shows schematically acquisition of signals using water bottom cables (ocean bottom cables “OBCs”).

FIG. 6 shows an example computer system that may be used in some embodiments.

### DETAILED DESCRIPTION

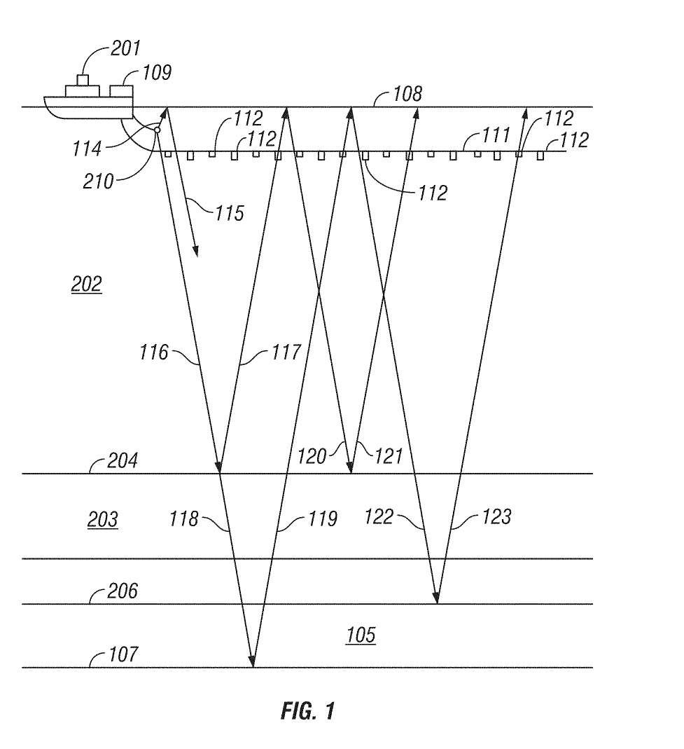

FIG. 1 shows an example of acquiring marine seismic data that can be used with a method according to the present disclosure. A seismic vessel 201 is shown schematically moving along the surface 108 of a body of water 202 above a portion 203 of the subsurface that is to be surveyed. Beneath the water bottom 204, the portion 203 of the subsurface may contain formations of interest such as a layer 105 positioned between an upper boundary 206 and lower boundary 107 thereof. The seismic vessel 201 contains seismic acquisition control and data recording equipment, designated generally at 109. The seismic acquisition control and data recording equipment 109 includes navigation control, seismic energy source control, seismic sensor control, and signal recording devices, all of which may be of types well known in the art.

The seismic energy source control device (not shown separately) in the seismic acquisition control and data recording equipment 109 causes a seismic source 210 towed in the body of water 202 by the seismic vessel 201 (or by a different vessel) to actuate at selected times. The seismic source 210 may be of any type well known in the art of seismic acquisition, including air guns or water guns, or in some embodiments arrays of air guns. Seismic streamers 111 may also be towed in the body of water 202 by the seismic vessel 201 (or by a different vessel) to detect acoustic wave fields initiated by the seismic source 210 and reflected from acoustic impedance interfaces present in the environment surrounding the seismic source 210 and the streamers 111. Although only one seismic streamer 111 is shown in FIG. 1 for illustrative purposes, in some embodiments a plurality of laterally spaced apart seismic streamers (such as shown at 111) may towed behind the seismic vessel 201 or another vessel. The seismic streamers 111 contain longitudinally spaced apart seismic sensors to detect wave fields, including reflected wave fields from below the water bottom 204, initiated by actuation of the seismic source 210. In the present example embodiment the seismic streamers 111 may contain pressure responsive or pressure time gradient responsive seismic sensors such as hydrophones, shown generally at 112. The hydrophones 112 in some embodiments are disposed in multiple sensor arrays at longitudinally spaced apart intervals along the seismic streamers 111. Such arrays are known in the art to be used to attenuate seismic energy or components thereof propagating in a direction along the length of the streamers 111 by selecting a suitable spacing between individual sensors in each such array and in some manner combining the signal output of the sensors in each such array, However, the type of seismic sensors used in any embodiments and their particular locations along the seismic streamers 111 are not intended to limit the scope of the present disclosure.

Each time the seismic source 210 is actuated, an acoustic wave field travels in spherically expanding wave fronts outwardly from the seismic source 210. The propagation of the wave fronts will be illustrated herein by ray paths which are perpendicular to the wave fronts. An upwardly traveling wave field, designated by ray path 114, will reflect from the water-air interface at the water surface 108 and then travel downwardly, as shown by ray path 115, where the wave field may be detected by one or more of the hydrophones 112 in the seismic streamers 111. Such a reflection from the water surface 108, as shown by ray path 115 contains no useful information about subsurface formations of interest below the water bottom 204. However, such surface reflections, also known as “ghosts”, act as secondary seismic sources with a certain time delay from the time of initiation or actuation of the seismic source 210.

The downwardly traveling wave field propagating directly from the seismic source 210 (that is, not having first been reflected from the water surface 108), shown by ray path 116, will reflect from the earth-water interface at the water bottom 204 and then travel upwardly, as shown by ray path 117, where the wave field may be detected by one or more of the hydrophones 112. Such a reflection at the water bottom 204, as shown by ray path 117, contains information about the water bottom 104. Ray path 117 is an example of a “primary” reflection, that is, a reflection originating from a boundary in the subsurface. The downwardly traveling wave field, as shown by ray path 116, may also propagate through the water bottom 204 as shown by ray path 118, reflect from a layer boundary, such as shown at 107, of a layer (representing an acoustic impedance boundary), such as shown at 105, and then travel upwardly, as shown by ray path 119. The upwardly traveling wave field, shown by ray path 119, may then be detected by the hydrophones 112. Such a reflection from a layer boundary 107 contains useful information about a formation of interest 105 and is also an example of a primary reflection.

The acoustic wave fields will continue to reflect from interfaces such as the water bottom 204, water surface 108, and layer boundaries 106, 107 in combinations. For example, the upwardly traveling wave field shown by ray path 117 will reflect from the water surface 108, continue traveling downwardly as shown by ray path 120, may reflect from the water bottom 104, and continue traveling upwardly again as shown by ray path 121, where the wave field may be detected by the hydrophones 112. Ray path 121 is an example of a multiple reflection, also called simply a “multiple”, having therein energy from multiple reflections from interfaces. Similarly, the upwardly traveling wave field shown by ray path 119 will reflect from the water surface 108 and continue traveling downwardly as shown by ray path 122. Such reflected energy as shown by ray path 122 may be detected by one or more of the hydrophones 112, thus creating a ghost referred to as a “receiver side ghost”, the effects of which on the desired seismic signal are similar in nature to the previously described ghost. The seismic energy may reflect off a layer boundary 106 and continue traveling upwardly again in ray path 123, where the wave field may be detected by the hydrophones 112. Ray path 123 is another example of a multiple reflection, also having multiple reflections in the subsurface.

The hydrophones 112 are shown as single sensors for clarity of the illustration provided by FIG. 1. Other embodiments may include combinations of individual sensors or sensor arrays, including without limitation, combination hydrophones and particle motions sensors such as geophones or accelerometers. In surface-related multiple elimination (SRME) methods known in the art, multiples are predicted from primaries by a multi-dimensional spatial convolution process. However, the same relationship between primaries and multiples can be used to describe a deconvolution process, where multiples are transformed into primaries. This process maps primaries into a focal point, first-order multiples into primaries, second-order multiples into first-order multiples, and so on. It follows that multiples contain equivalent information about the subsurface to that contained by the primaries. There are also such circumstances where multiples add to signal rather than being unwanted noise. This property of multiples may be used, for example, in order to reconstruct missing near offsets (“offset” being a term used to mean a horizontal distance between the seismic source and any one seismic sensor or the equivalent detection point of an array as described above), missing sensors or missing “shots” from the multiples measured in the observed data at the available offsets (van Groenestijn and Verschuur, 2009a; Lin and Herrmann, 2013; Lopez and Verschuur, 2015b).

In the case of very short offsets, primary reflection information may be consistently absent in the entire data set and it cannot be filled using the principle of reciprocity. The near-offset traces typically contain the strongest energy as most of the event apices fall inside it. This area is the most relevant for multiple prediction and also the most complicated to interpolate. This is a problem in very shallow water because the primary reflections, that might normally be used to predict multiples, are missing. This is a reason surface related multiple elimination (SRME) does not perform well in shallow water. However, given data with multiples measured at the available offsets, it is possible to derive a multichannel prediction filter with a wave theoretical foundation. The filter may be designed by minimizing energy in the output of a prediction error process, in a somewhat analogous manner to predictive deconvolution. By use of the focal transform (see, Berkhout and Verschuur, 2006), it is constrained to be composed of a sparse set of hyperbolic functions based upon the wave equation. This filter is can be an excellent approximation of the water bottom reflector and any other reflectors included.

In some embodiments, a migration operator may be used to compute a sparse representation of the estimated multichannel prediction filter and the sparsity constraint is enforced in the migrated domain. In some embodiments, the migration operator is a Stolt migration operator.

In some embodiments, at least one of the following functions may be used to compute a sparse representation of the estimated multichannel prediction filter and the sparsity constraint is enforced in the transformed domain: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

Given this filter one may proceed to predict the multiples and either subtract them directly or adaptively subtract them. The fact that surface multiples in marine seismic data are themselves combinations of primaries is the basis of a variety of powerful data driven approaches to SRME. These approaches do not rely on restrictive assumptions about the geology or move-out behavior of the multiples. They do however place considerable demands on data acquisition. These acquisition constraints become particularly severe in shallow water situations, where the main generator of the multiples is the water bottom primary reflection. The recent work on ‘EPSI’ and ‘closed-loop SRME’ propose an inversion based solution to this problem, where primaries are constructed from the available primaries and multiples (van Groenestijn and Verschuur, 2009b; Lopez and Verschuur, 2015a; Lin and Herrmann, 2016). However, a full SRME inversion can be a difficult and costly process considering the large number of multi-dimensional convolutions required for such an inversion process.

Nevertheless, a more limited inversion for the estimation of water bottom primary Green's function at offsets close to zero, in the form of multi-dimensional prediction filter, using the multiples at the larger offsets is possible with a beneficial outcome. This prediction filter predicts first order multiples from primaries, second-order multiples from first-order multiples, and so on. Similarly, the inverse of this filter can predict primaries from first-order multiples, first-order multiples from second-order multiples and so on again. That means, the inverse of this multidimensional prediction filters can also be used in reconstructing the water bottom reflections in the near offsets. This is very helpful in removing the shallow water multiples for the widest streamers, where the near-offset gaps are large. In this paper, we present this inversion based approach to derive the multi-dimensional prediction filter with the help of double focal transform operators, we term this process Shallow Water Attenuation of Multiples by Inversion (SWAMI).

Having explained the general principles of methods according to the present disclosure, more detailed explanation of the theoretical basis for example implementations will be explained.

The monochromatic expression of surface seismic data (P), which includes surface related multiple reflections (multiple), may be represented by the following feedback model (Berkhout, 1982):

P=P₀+P₀AP (1)

where, P₀ represents seismic data without surface multiples (Primaries+Internal multiples) and A is known as the surface operator (A=S⁻¹R^{∩}); R^{∩} being the surface reflectivity and S being the source wavelet). By rearranging the above equation (1), the primary reflection-only wavefield (P₀) can be written as:

P₀=P−P₀AP (2)

If F=P₀A, it is possible to derive an estimate of F by assuming the best choice of F occurs when the energy of right hand side of Eq. (2) is minimized:

$${J}_{ω}^{( LS )} = {\sum }_{ω} {‖ P - \hat{F} P ‖}_{2}^{2} = min \qquad ( 3 )$$

Here, \hat{F} is known as the full multichannel prediction filter (Biersteker, 2001; Yang and Hung, 2012). This full multichannel prediction filter by a large scale inversion of the above Eq. (3) would be computationally expensive to perform on a full seismic data set. However, the prediction filter (F_{w}) associated with the sea-bed reflector and any other reflectors included beneath the sea-bed can be estimated using a windowed version of the full seismic data set (P), which includes the water layer reverberations and all (source-side and receiver-side) peg-leg multiples only. These filters are truncated in time during each iteration of the inversion process. Truncation helps to avoid having more terms in the estimate of filters, which could over predict first order multiples and primaries from the deeper layers.

An objective of a method according to the present disclosure is to find best possible accurate multichannel prediction filters for the water bottom and all included thin formation boundary layers just beneath the water bottom to remove all the complex water-layer related multiples as well as to reconstruct a large portion of the missing near offset data. In order to compute such accurate prediction filters for the above purpose, a novel parametrization may be used. Such parameterization may include a transform domain in which the energy of the prediction filters is compressed and also a parameter selection method in the transform domain to separate the parameters representing the primary Green's function from the parameters accounting for aliasing noise.

In an embodiment of a method according to the present disclosure one may use the double focal transform (Berkhout and Verschuur, 2006) as a transform domain, which has as its purpose focusing primary reflections into localized events. Such focal transform domain can compress the primary reflection energy, a property that will be useful when separating primary signals from under-sampling noise in the focal domain. For the parameter selection method in the transform domain, one may use a sparsity-promoting regularization norm ∥⋅∥ₛ applied to the focal domains of the prediction filters. With this extra constraint it is possible to drive the algorithm towards a sparse representation in the focal domains. This condition will remove the energy from aliasing artifacts to concentrate energy in the primary events only.

The focal transform of the multichannel prediction filters may be expressed as:

\hat{F}=W^{T}\hat{X}W (4)

where, W is a one-way extrapolation operator and where \hat{X} represents the focal domain of the multichannel prediction filters. This is a type of hyperbolic decomposition. In the case of isotropic homogeneous media, the expression for W for a dipole point response can be expressed as:

$${W}_{3 D} ( x , y , ω , Δ z ) \approx \frac{jk}{2 π} ( cos ( φ ) ) \frac{exp ( - jkr )}{r} \qquad ( 5 )$$

Where r represents the distance between the source and each sensor, wherein, (r=\sqrt{x²+y²+Δz²}), ϕ represents the angle between the source-receiver vector and the z-axis, and k=ω/c is the magnitude of the wave-number vector k=(kₓ,k_{y},k_{z}) (with c being the propagation velocity). In this description, one may use some water velocity information (e.g., 1500 m/s) to create the propagation operators which will allow back-propagating the wavefields. Note that, the term kz is defined by the following dispersion relationship:

k²=kₓ²+k_{y}²+k_{z}² (6)

Another way to achieve focusing is to work with two-way operators G (Berkhout and Verschuur, 2006). Similar to equation (4), one can write the expression \hat{F}=\hat{X}G where, G is a two-way extrapolation operator. This is also referred to as a “single-sided inverse focal transform”. Note that one-way operators W act on both the source and receiver dimension in order to focus the data. In 3 dimensional (3D) acquisition scenarios, achieving good sampling of both the dimensions to allow application of W can be challenging and expensive. Using the single-sided focal transform partially alleviates this problem as it acts only on the source or receiver dimension, which allows more practical application.

The choice of using the focal transform for the transform domain is justified by the fact that due to its focusing characteristic, the focal transform is able to compress the energy of highly curved events into localized events, making it useful for shallow water applications, where the events to reconstruct are strongly curved in the near offsets.

Using Eq. (3) and (4), the minimization may be expressed as:

$$J = {J}_{ω}^{( LS )} + {J}_{t}^{( reg )} = {\sum }_{ω} {‖ P - \hat{F} P ‖}_{2}^{2} + λ {\sum }_{t} {‖ \hat{x} ‖}_{s} . \qquad ( 7 )$$

where \hat{x} is the inverse Fourier transform of the focal domain of \hat{F}, t represents a time-slice and λ is a user-defined regularization constant (typically ≈0.1-0.3) which controls the strength of the sparsity constraint. The norm ∥.∥ₛ represents any sparsity-promoting norm, e.g., L1 or Cauchy, which is applied to every time slice in \hat{x}. Using any gradient-based inversion procedure it is possible to determine a set of model parameters that minimizes the objective function J. Inversion updates for the focal domains are given by the expressions Δ\hat{X}^{(LS)}=−∇J_{ω}^{(LS)} and Δ\hat{x}=−∇_{\hat{x}}Jₜ^{(reg)} providing the expression:

Δ\hat{X}=Δ\hat{X}^{(LS)}+Δ\hat{x}^{(reg)} (8)

and in which:

Δ\hat{X}^{(LS)}=2W*(P−\hat{F}P)P^{H}W^{H} (9)

and

Δ\hat{x}^{(reg)}=−λ∇_{\hat{x}}_{^{(reg)}}∥\hat{x}∥ₛ (10)

in which the superscripts .* and .^{H} refer to complex conjugation and Hermittian transpose, respectively. The updates Δ\hat{X} may then be used to renew the estimate of the focal domain of prediction filters in every iteration using the recursion formula:

\hat{X}⁽ⁱ⁺¹⁾=\hat{X}⁽ⁱ⁾+αΔ\hat{X}⁽ⁱ⁾ (11)

in which the scaling parameter α is chosen using

$${min}_{α} J ( {\hat{X}}^{( i )} + αΔ {\hat{X}}^{( i )} ) .$$

The multichannel prediction filter may be estimated by minimizing the energy between the input data P and the multiples estimate, FP, however, the term FP does not constitute all types of short-period multiples. The term FP can only model water-layer multiples and the source-side peg-leg multiples. To model the receiver-side peg-leg multiples as well, another term called PF^{T} may be used. By including both terms (FP and PF^{T}), the water-layer multiples and the symmetric reverberations are kinematically predicted correctly, however, some multiples are predicted twice by the cross terms. Therefore a third term, FPF^{T}, is required. Even so, over predicted first order water layer multiples may not be corrected, and an additional correction term (FP_{w}) may be applied (see, Lokhstanov, 1995).

Therefore, the full multiple model including all peg-leg multiples can be computed by the following expression:

M=FP+PF^{T}FPF^{T} (12)

where, the superscript T represents the transpose of the matrix. Note that terms in equation (12) involve at least four multidimensional convolutions. However, if the benefits of adaptive subtraction are used, then the multiple model can be predicted by the following equation only (avoiding extra convolution terms):

M=f*(FP+PF^{T}) (13)

where f is an adaptive filter. So long as the adaptive filter can change fast enough, even though some multiples are predicted twice, the filter can correctly modify the amplitudes accordingly. In the event that the filter is unable to adapt fast enough then the full model of Eq. (12) is used. The foregoing process is referred to as Shallow Water Attenuation of Multiples by Inversion (SWAMI).

SWAMI is a data-driven de-multiple method especially designed to operate in shallow water. The derived multichannel prediction filter (F) can also be used to reconstruct water bottom reflections in near offsets. In practice, one round trip of feedback model (Eq. (1)) adds a further order of multiples to the wavefield, meaning that this is equivalent to multiplication of the multichannel prediction filter (F) with the previously-generated set of multiples. So, the multichannel prediction filter predicts first order multiples from primaries, second-order multiples from first-order multiples, and so on. Similarly, the inverse of the multichannel prediction filter can predict primaries from first-order multiples, first-order multiples from second-order multiples and so on, i.e., removal of one round trip, converting higher order multiples to lower order multiples (Hargreaves, 2006). Reconstructing the data at near offsets using the inverse of these prediction filters is a process element for SWAMI to predict the multiple model accurately for the wide tow streamer data where the near offset gaps are large. This also helps to reduce edge effects in the SWAMI multiple model.

Starting again from the assumption that

F=P₀A

FA⁻¹=P₀ (14)

After substituting this expression of P₀ into the feedback model equation (1), the following equation is obtained:

P=FA⁻¹+FP

F⁻¹P=A⁻¹+P (15)

where the inverse of the multichannel prediction filter can be approximated by its adjoint function according to the expression:

F⁻¹≈F^{H}[FF^{H}+ε²I]⁻¹ (16)

The term A⁻¹ in Eq. (15) is simply a source wavelet. As previously stated, A is a surface operator represented by the expression:

A=S⁻¹R^{∩}=−S⁻¹ (17)

in which R^{∩} is surface reflectivity. Surface reflectivity for purposes of methods according to the present disclosure may be approximated by the constant (−1). In such event, A⁻¹ may be rewritten as

A⁻¹=−S (18)

The source wavelet occupies the place in the seismic data represented by zero offset and zero time, therefore the source wavelet may be muted in the space-time domain. Muting provides reconstructed seismic data in the following form:

A⁻¹+P→mute→P (19)

The foregoing reconstructed data then can be used to fill the near offset gaps for the water bottom reflections, which helps to improve the multiple model at the nearest available offset as well as to suppress the edge effects. Near-offset gap not only results in unpredictable multiple events, but also introduces edge effects in the extrapolation process due to the abrupt change in the measured data and the prediction filter. Therefore, the missing data in the near offset gap may be reconstructed prior to multiple prediction.

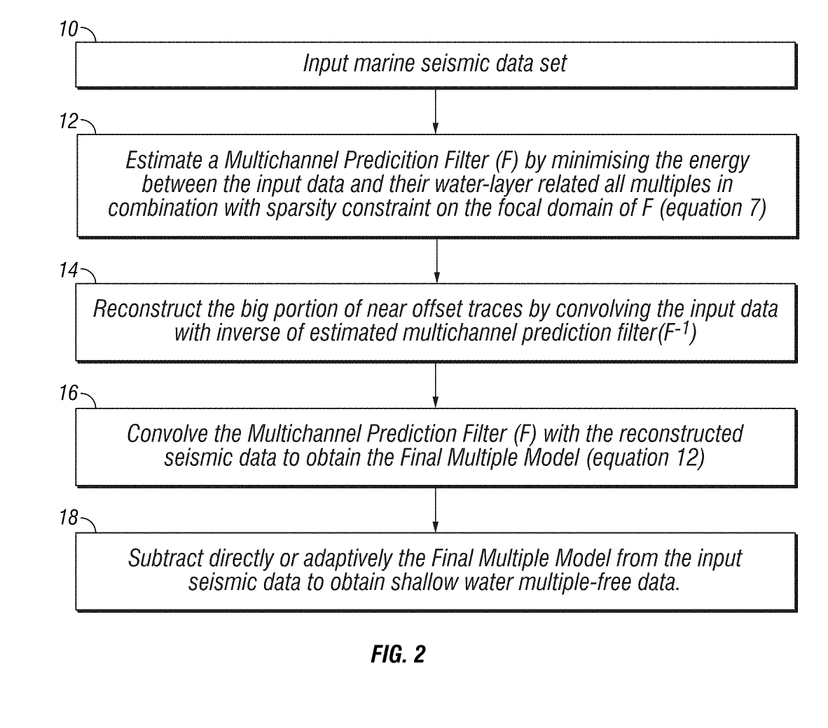

FIG. 2 shows a flow chart of an example implementation of a SWAMI method. The example method starts at 10 with entering acquired seismic data (FIG. 1) as input to a computer system (FIG. 9). At 12, a multichannel prediction filter (F) is estimated by minimizing the energy between the input marine seismic data (P) and their water layer related multiples (FP) using, e.g., Eq. (7). Once the filter is estimated, at 14 near offset traces are reconstructed by convolving the input seismic data (P) with the inverse of the filter (F⁻¹), e.g., using Eq. (15). At 16 a final multiple model is generated by convolving the estimated filter with the reconstructed data using, e.g., Eq. (12). At 18, the final multiple model is directly or adaptively subtracted from the input seismic data to obtain shallow water multiple-free seismic data.

The method described above has some practical limitations when working with actual three dimensional (3-D) seismic data sets. One such limitation is based on the fact that in order to apply a method as explained with reference to FIG. 2, the input seismic data should be organized inside a large dense data matrix and regularization of sources and sensors should be performed beforehand. Due to economic considerations, the seismic data acquisition geometry may be designed to have a source interval that is two or three times the sensor interval. Seismic data so acquired may have an irregular geometry (e.g., missing shots, missing sensor traces, cable feathering, etc.) which is a characteristic that does not mesh with a processing method that works best with regular acquisition geometry. One cost-effective way of dealing with irregular geometry may be to regularize a subset of subsurface two dimensional (2-D) lines in a 2-D manner, predict the multiples for those lines, de-regularize the predicted multiples, and adaptively subtract each line of predicted multiples from the input 2-D data lines. Such method may result in the regularization and especially the de-regularization processes being inaccurate, which leads to substantial errors in the predicted multiples.

One possible solution to irregular acquisition geometry issues is to use 3-D general surface multiple prediction (GSMP). (See, Dragoset et al., 2008). This method avoids any initial interpolation of the seismic data before the prediction process via on-the-fly differential normal moveout interpolation. Instead of trying to change the seismic data to fit the algorithm, GSMP changes the algorithm to fit the seismic data. GSMP provides a technique for calculating the convolution of two large data matrices in a computationally efficient way. Therefore, in order to alleviate the above identified limitations, a SWAMI method may be implemented with the following adaptations:
The matrix products in the method described with reference to FIG. 2 (data-data convolutions) are replaced by GSMP products.
The GSMP method may be generalized to include both convolution and correlation type of products by replacing trace by trace convolutions in the method of FIG. 2 with trace by trace correlations.

Synthetic Data Examples

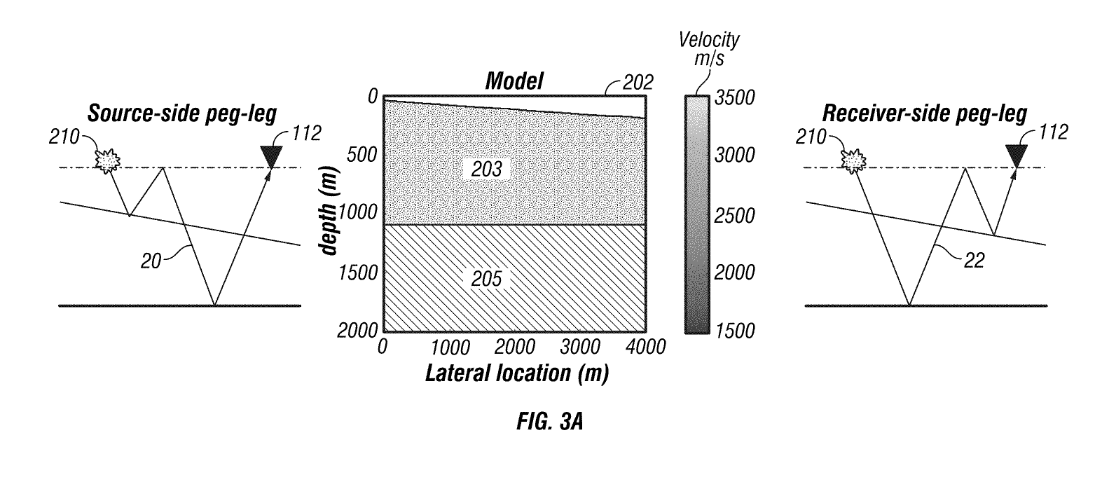

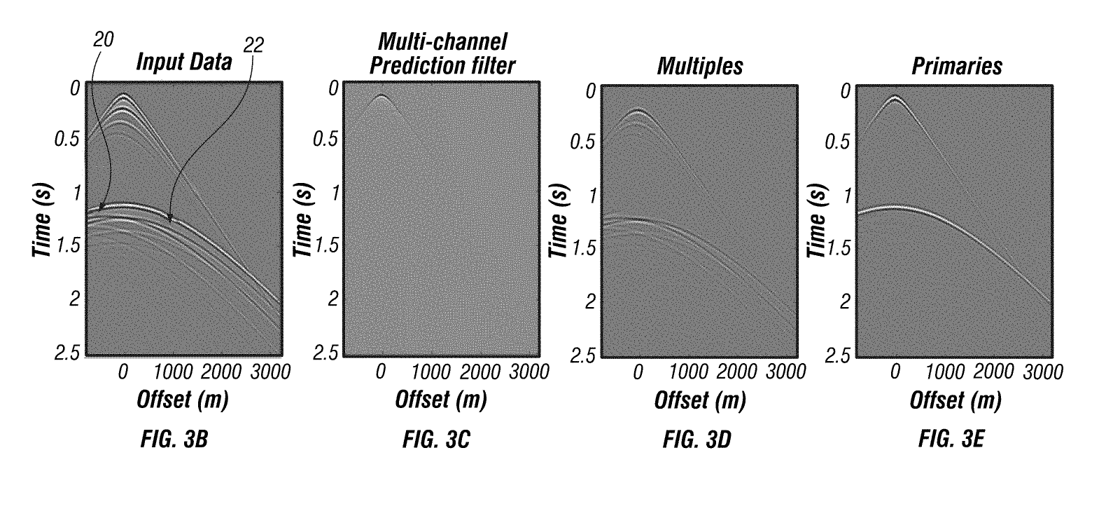

The above-denoted SWAMI method may be demonstrated using a simple two layer model of a formation below the bottom of a body of water wherein the water bottom has a 3 degree dip as shown in FIG. 3A. The water depth in the model is in the range of 50 to 150 meters. The present example embodiment is to show that the SWAMI method according to the present disclosure is able to predict and remove shallow water-layer related multiples, including source-side and receiver-side peg-leg multiples. First is shown an example without near offset sensor signal gap and then the same example formation structure is repeated with near offset sensor signal gaps. FIG. 3B shows the input seismic data resulting from the source being positioned at x (offset)=800 meters. Note that because of the dipping water bottom layer, the source-side and receiver-side peg-leg multiples are two separate events crossing each other at the zero offset location (indicated at 20, and 22, respectively). FIG. 3C shows the multichannel prediction filter estimated from the input seismic data, which shows that the prediction filter is an excellent approximation to Green's function of the water bottom reflector. Using Eq. (12), the multiples were modelled and subtracted directly from the input seismic data as shown in FIGS. 3D and 3E, respectively. Note that the peg-leg multiples were predicted with the correct amplitudes.

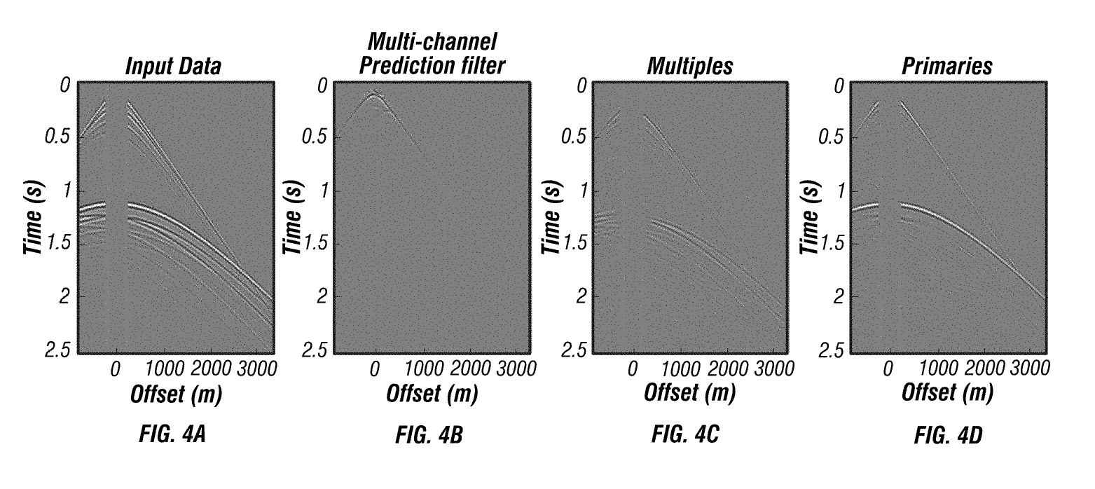

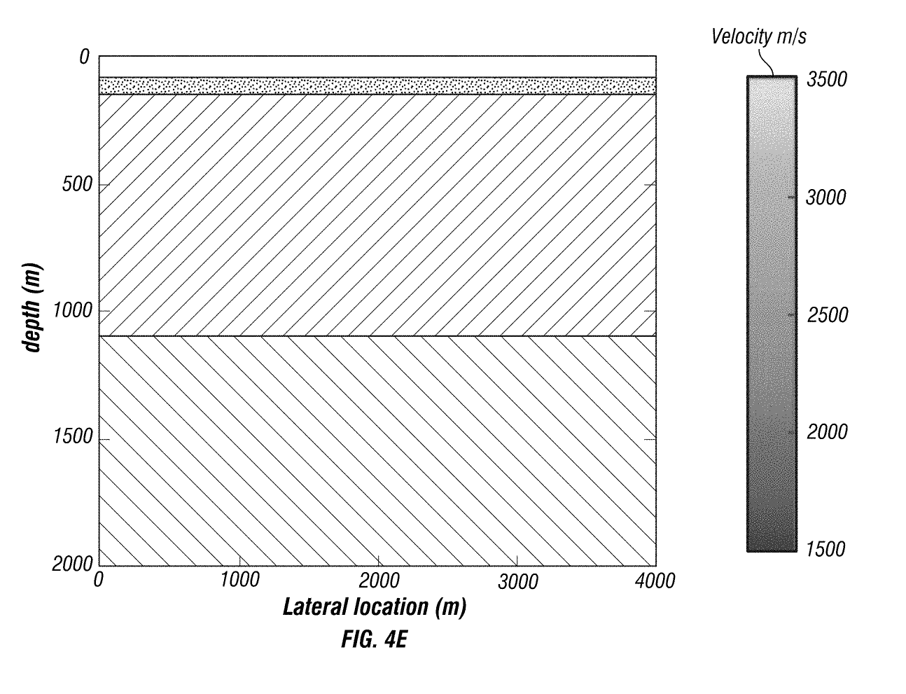

A second example is shown in FIG. 4A when there is a near-offset seismic signal gap of 400 m for a simulated formation layer set as shown in FIG. 4E. It can be observed that the multichannel prediction filters are accurately estimated again even with the input data having a near offset gap. In this case, the estimated prediction filters were also used to reconstruct some of the near-offset water bottom reflections using Eq. (15), such that improved the multiple model results. FIGS. 4A through 4D show, respectively, a) modelled shot gather data with 400 m near-offset gap; b) the estimated multichannel prediction filter, c) predicted multiples, and d) the result after direct subtraction of the predicted multiples from the input data.

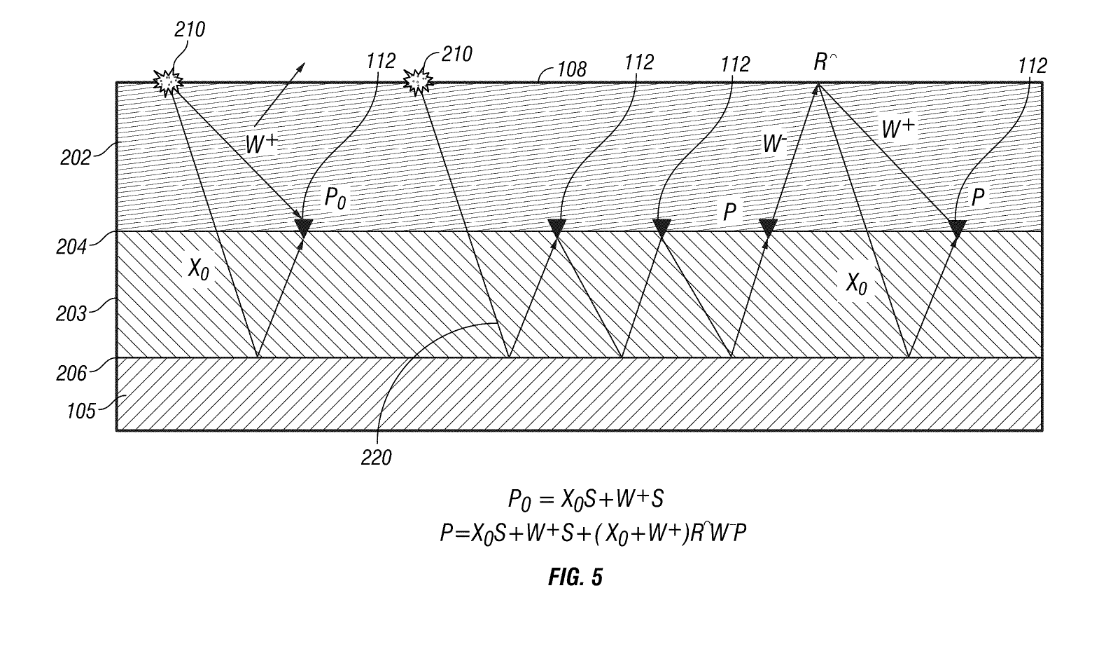

Methods according to the present disclosure may also be used in connection with seismic signals acquired using sensor cables disposed on the water bottom (204 in FIG. 1). Such cables may comprise both pressure responsive sensors and particle motion responsive sensors. Such cables are known in the art by the name “ocean bottom cables” or “OBCs.” Referring to FIG. 5, by making use of detail hiding operator notation (see, Berkhout, 1982), the total pressure wavefield measured at the ocean bottom receivers may be described in terms of direct arrivals, primary reflections and multiple reflections. Positions of the seismic energy source 210 at the time of actuation are shown. Seismic sensors 112 are shown disposed at spaced apart locations along the water bottom 204. In the present example embodiment, the sensors 112 may be pressure sensors, e.g., hydrophones as described with reference to FIG. 1. It will be appreciated by those skilled in the art that OBCs may also comprise particle motion responsive sensors, either collocated with pressure responsive sensors or disposed at other spaced apart locations along the OBC. For purposes of description of example embodiments of methods according to the present disclosed, the description may be limited to pressure responsive sensors.

The direct arrival detected by each of the sensors 112 may be represented by the expression W⁺S. Such expression may be obtained from a matrix multiplication of the down-going water layer 202 propagation operator, W⁺, and a source matrix S.

The primary reflections, which may be denoted by X₀S, may be obtained by a matrix multiplication of the primary reflection impulse responses (Green's functions), X₀ with the source matrix S. The primary reflection impulse responses X₀ describe the propagation of wavefields from the water surface 108, after (multiple) reflection(s) from below the water bottom 204, back upward to the water bottom 204. Such reflection(s) may be from formation boundaries, e.g., at 206 separating formations 203 and 105.

Free surface multiple reflections, (X₀+W⁺)R^{∩}W⁻P, are detected by the sensors 112 on the water bottom after the reflection from the water surface 108 by the free surface reflection operator R^{∩}. An upward water propagation operator W⁻ may be used to propagate the detected seismic pressure signals P from the water bottom 204 to the water surface 108. The upward water propagation operator W⁻ is the transposed matrix of W⁺. The ray path of such a multiple reflection is depicted in FIG. 5 as ray path 220. After adding all the components just described enables determining a complete forward model of OBC pressure signals P as:

P=X₀S+W⁺S+(X₀+W⁺)R^{∩}W⁻P (20)

Note that P is the total recorded OBC pressure signal measured at the water bottom 204 which includes the direct wavefield, primary reflections, source-side free surface multiple reflections and sensor ghosts (sensor side reverberations). One may combine the primary reflections, X₀S and the direct arrival wavefield, W⁺S and denote them as “total primaries” P₀, which may be expressed as:

P₀=X₀S+W+S (21)

After substituting the foregoing expression for P₀ into equation (20), the following expression may be obtained:

$$\begin{matrix}P = ( {X}_{0} + {W}^{+} ) S + ( {X}_{0} + {W}^{+} ) {R}^{⋒} {W}^{-} P \\ = ( {X}_{0} + {W}^{+} ) S + ( {X}_{0} + {W}^{+} ) {SS}^{- 1} {R}^{⋒} {W}^{-} P \\ = {P}_{0} + {P}_{0} {AW}^{-} P\end{matrix} \qquad ( 22 )$$

By rearranging equation (22), the total primaries (P₀) can be described by the expression:

P₀=P−P₀AW⁻P (23)

By letting:

F=P₀AW⁻

it is possible to derive an estimate of F by assuming that a best choice of the filter F occurs when the energy of right hand side of equation (23) is minimized, e.g., according to an expression such as:

$${J}_{ω}^{( LS )} = {\sum }_{ω} {‖ P - \hat{F} P ‖}_{2}^{2} = min \qquad ( 24 )$$

Note that Eq. (24) is a very similar type objective function as that shown in Eq. (3), however, in the present example embodiment, pressure signals P here are those detected at the OBC sensors 112 and the prediction filter F is associated with P₀AW⁻ Therefore, the formulation of the present example embodiment of the method is equally applicable for attenuating short-period multiples in OBC data without requiring any extra calculations related to the position of the seismic sensors 112.

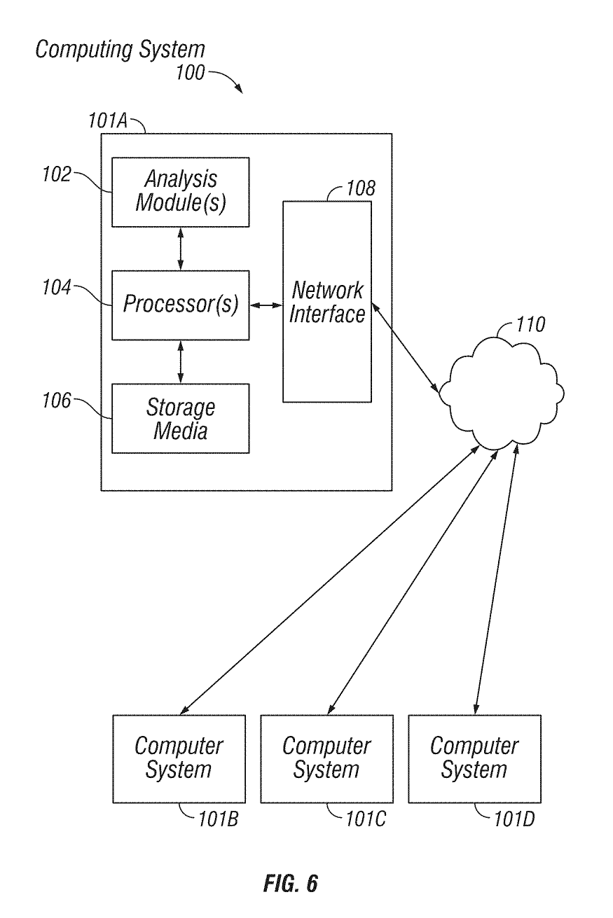

All of the above calculations may be performed in any general purpose or purpose specific computer or processor. FIG. 6 shows an example computing system 100 in accordance with some embodiments. The computing system 100 may be an individual computer system 101A or an arrangement of distributed computer systems. The individual computer system 101A may include one or more analysis modules 102 that may be configured to perform various tasks according to some embodiments, such as the tasks explained with reference to FIGS. 2-5. To perform these various tasks, the analysis module 102 may operate independently or in coordination with one or more processors 104, which may be connected to one or more storage media 106. A display device 105 such as a graphic user interface of any known type may be in signal communication with the processor 104 to enable user entry of commands and/or data and to display results of execution of a set of instructions according to the present disclosure.

The processor(s) 104 may also be connected to a network interface 108 to allow the individual computer system 101A to communicate over a data network 110 with one or more additional individual computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be at a well drilling location, while in communication with one or more computer systems such as 101C and/or 101D that may be located in one or more data centers on shore, aboard ships, and/or located in varying countries on different continents).

A processor may include, without limitation, a microprocessor, microcontroller, processor module or subsystem, programmable integrated circuit, programmable gate array, or another control or computing device.

The storage media 106 may be implemented as one or more computer-readable or machine-readable storage media. Note that while in the example embodiment of FIG. 6 the storage media 106 are shown as being disposed within the individual computer system 101A, in some embodiments, the storage media 106 may be distributed within and/or across multiple internal and/or external enclosures of the individual computing system 101A and/or additional computing systems, e.g., 101B, 101C, 101D. Storage media 106 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that any other embodiment of a computing system may have more or fewer components than shown, may combine additional components not shown in the example embodiment of FIG. 6, and/or the computing system 100 may have a different configuration or arrangement of the components shown in FIG. 6. The various components shown in FIG. 6 may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, GPUs, coprocessers or other appropriate devices. These modules, combinations of these modules, and/or their combination with general hardware are all included within the scope of the present disclosure.

Methods according to the present disclosure may provide the capability to attenuate or remove water layer multiple reflections from marine seismic data wherein the water depth is relatively shallow and/or at near offsets that may limit the use of different methods for multiple reflection attenuation.

References cited herein include the following:
Berkhout, A. J., 1982, Seismic migration, imaging of acoustic energy by wave field extrapolation, A. theoretical aspects: Elsevier.
Berkhout, A. J., and D. J. Verschuur, 2006, Focal transformation, an imaging concept for signal restoration and noise removal: Geophysics, 71, A55-A59.
Biersteker, J., 2001, Magic: Shell's surface multiple attenuation technique: 71st Ann. Internat. Mtg., Expanded Abstracts, Soc. of Expl. Geophys., 1301-1304.
Dragoset, W. H., I. Moore, M. Yu, and W. Zhao, 2008, 3D general surface multiple prediction: An algorithm for all surveys: 78th Ann. Internat. Mtg., Expanded Abstracts, Soc. of Expl. Geophys., 2426-2430.
Hargreaves, N., 2006, Surface multiple attenuation in shallow water and the construction of primaries from multiples: 76th Ann. Internat. Mtg., Expanded Abstracts, Soc. of Expl. Geophys., 2680-2693.
Lin, T. T. Y., and F. J. Herrmann, 2013, Robust estimation of primaries by sparse inversion via one-norm minimization: Geophysics, 78, R133-R150.
2016, Estimation of primaries by sparse inversion with scattering-based multiple predictions for data with large gaps: Geophysics, 81, V183V197.
Lokhstanov, D., 1995, Multiple suppression by single channel and multichannel deconvolution in the tau-p domain: 65th Ann. Internat. Mtg., Expanded Abstracts, Soc. of Expl. Geophys., 1482{1485.
Lopez, G. A., and D. J. Verschuur, 2015a, 3D focal closed-loop SRME for shallow water: 85th Ann. Internat. Mtg., Expanded Abstracts, Soc. of Expl. Geophys., 4418-4422.
2015b, Closed-loop surface-related multiple elimination and its application to simultaneous data reconstruction: Geophysics, 80, V189V199.
van Groenestijn, G. J., and D. J. Verschuur, 2009a, Estimating primaries by sparse inversion and application to near-offset data reconstruction: Geophysics, 74, A23-A28.
2009b, Estimation of primaries and near-offset reconstruction by sparse inversion: Marine data applications: Geophysics, 74, R119-R128.
Yang, K., and B. Hung, 2012, Shallow water demultiple with seafloor reflection modeling using multichannel prediction operator: 82nd Ann. Internat. Mtg., Expanded Abstracts, Soc. of Expl. Geophys., 1-5.

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f), for any limitations of any of the claims herein, except for those in which the claim expressly uses the words “means for” together with an associated function.

What is claimed is:

1. A method for attenuating multiple reflections from marine seismic signals, comprising:
communicating as input to a computer seismic signals detected at a plurality of different spaced apart locations from a seismic energy corresponding to actuation of the seismic energy source in a body of water and;
in the computer, estimating a multichannel prediction filter by minimizing energy between the input seismic signals and seismic signals representing water layer multiple reflections in combination with forcing a sparsity constraint on the estimated multichannel prediction filter;
in the computer, reconstructing near offset seismic signals not present in the detected seismic signals by convolving the detected seismic signals with an inverse of the multichannel prediction filter;
in the computer, convolving the multichannel prediction filter with the reconstructed near offset seismic signals to obtain a final multiple reflection model; and
in the computer, subtracting the final multiple reflection model from the detected seismic signals to output from the computer multiple reflection attenuated seismic signals.

2. The method of claim 1 wherein a double-sided or single-sided focal transform is used to compute a sparse representation of the estimated multichannel prediction filter and the sparsity constraint is enforced in the focal domain.

3. The method of claim 1 wherein a migration operator is used to compute a sparse representation of the estimated multichannel prediction filter and the sparsity constraint is enforced in the migrated domain.

4. The method of claim 3 wherein the migration operator comprises a Stolt migration operator.

5. The method of claim 3 wherein a function used to compute the sparse representation of the estimated multichannel prediction filter and to enforce the sparsity constraint in the transformed domain comprises at least one of: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

6. The method of claim 1 wherein the subtracting is direct.

7. The method of claim 1 wherein the subtracting is adaptive.

8. The method of claim 1 further comprising correcting the detected seismic signals for irregularity in acquisition geometry by using, in the computer, three-dimensional general surface multiple prediction.

9. The method of claim 1 further comprising separately modeling the sensor-side peg leg multiple reflections by the term (PF) and the source-side multiples by the term (FP) and wherein symmetric multiple reflections which are modelled twice are corrected by an extra correction term (FPF^{T}), and wherein first order water layer multiples which are over predicted are corrected by an additional extra term (FP_{w}), wherein (PF) represents a sensor-side prediction filter applied to the detected seismic signals, (FP) represents a source side prediction filter applied to the detected seismic signals and F^{T} in (FPF^{T}) represents a transposition of the prediction filter and P_{w} represents the water bottom primary reflections.

10. A method for marine seismic surveying, comprising:
actuating a seismic energy source in a body of water;
detecting seismic signals at a plurality of spaced apart locations from the source, the seismic signals comprising at least one of water layer multiple reflection signals and reflections from at least one formation layer boundary below the water bottom;
communicating as input to a computer the detected seismic signals;
in the computer, estimating a multichannel prediction filter by minimizing energy between the input seismic signals and seismic signals representing water layer multiple reflections in combination with forcing a sparsity constraint on the estimated multichannel filter;
in the computer, reconstructing near offset seismic signals not present in the detected seismic signals by convolving the detected seismic signals with an inverse of the multichannel prediction filter;
in the computer, convolving the multichannel prediction filter with the reconstructed near offset seismic signals to obtain a final multiple reflection model; and
in the computer, subtracting the final multiple reflection model from the detected seismic signals to output from the computer multiple reflection attenuated seismic signals.

11. The method of claim 10 wherein a double-sided or single-sided focal transform is used to compute a sparse representation of the estimated multichannel prediction filter and the sparsity constraint is enforced in the focal domain.

12. The method of claim 10 wherein a migration operator is used to compute a sparse representation of the estimated multichannel prediction filter and the sparsity constraint is enforced in the migrated domain.

13. The method of claim 12 wherein the operator is a Stolt migration operator.

14. The method of claim 12 wherein a function used to compute the sparse representation of the estimated multichannel prediction filter and to enforce the sparsity constraint in the transformed domain comprises at least one of: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

15. The method of claim 10 wherein the subtracting is direct.

16. The method of claim 10 wherein the subtracting is adaptive.

17. The method of claim 10 further comprising correcting the detected seismic signals for irregularity in acquisition geometry by using, in the computer, three-dimensional general surface multiple prediction.

18. The method of claim 10 further comprising separately modeling the sensor-side peg leg multiple reflections by the term (PF) and the source-side multiples by the term (FP) and wherein symmetric multiple reflections which are modelled twice are corrected by an extra correction term (FPF^{T}), and wherein first order water layer multiples which are over predicted are corrected by an additional extra term (FP_{w}), wherein (PF) represents a sensor-side prediction filter applied to the detected seismic signals, (FP) represents a source side prediction filter applied to the detected seismic signals, F^{T} in (FPF^{T}) represents a transposition of the prediction filter and P_{w} represents the water bottom primary reflections.
